(19) United States
(12) Patent Application Publication
(10) Pub. No.: US 2009/0230044 A1
(43) Pub. Date: Sep. 17, 2009

(54) Microfluid Chip Cleaning

(75) Inventor: Fritz Bek, Pfinztal (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/048,032

(22) Filed: Mar. 13, 2008

(51) Int. Cl. B08B 3/12; B01D 15/00

(52) U.S. Cl. 210/198.1; 134/1; 134/105

(57) ABSTRACT

A method of cleaning a microfluidic chip (101) comprising at least one microstructure (105, 106) containing a material (111), wherein the method comprises removing the material (111) from the at least one microstructure (105, 106) so as to at least partly empty the at least one microstructure (105, 106).

This application is the National Stage of International Application No. PCT/EP2005/054652, filed on 19 Sep. 2005 which designated the United States of America, and which international application was published as Publication No. WO 2007/038976.

### BACKGROUND ART

The present invention relates to microfluidic chip cleaning.

In a microfluidic system for investigating fluidic analyts using microchannels, two glass chips may be provided. In a first glass chip, channels may be etched. In a second glass chip, through holes may be formed. After bonding the first glass chip or substrate to the second glass chip or substrate in such a manner that the through holes are aligned with respect to the channels, fluid may be inserted and pumped or transported using electric forces through the microstructures. The microstructures may be filled with a gel material, for instance in the context of a gel electrophoresis device. After having bonded two substrates, a caddy, that is to say a support element, may be connected to the two bonded substrates to form a microfluidic chip which is adapted to be inserted in a measurement device for performing a microfluidic analysis experiment.

Examples for such microfluidic chips are disclosed, for instance, in EP 1,447,134 A1 of the same applicant Agilent Technologies or in U.S. Pat. No. 6,280,589 B1.

However, after having used such a microfluidic chip for performing a microfluidic analysis experiment multiple times, it may happen that a gel material or a remnant of an analyt material becomes partially solid and may block at least partially microchannels of the microfluidic chip. This may deteriorate the functionality of the microfluidic chip device, since such a blocking of microchannels may prevent analyt from being properly transported through the channels under the influence of a mechanical force or an electrical force.

### DISCLOSURE

It is an object of the invention to enable an efficient operation of a microfluidic chip. The object is solved by the independent claims. Further embodiments are shown by the dependent claims.

According to an exemplary embodiment of the present invention, a method of cleaning a microfluidic chip (for instance for performing a biochemical analysis like a gel electrophoresis experiment) comprising at least one microstructure (for instance horizontal microchannels and/or vertical microholes formed in a substrate) containing a material (for instance gel which has been solidified by multiple prior use of the microfluidic chip) is provided, wherein the method comprises removing the material from the at least one microstructure so as to at least partly empty the at least one microstructure (for instance to make the microfluidic chip fit for reuse).

According to another exemplary embodiment, an apparatus for cleaning a microfluidic chip comprising at least one microstructure containing a material is provided, wherein the apparatus comprises a removing unit adapted for removing the material from the at least one microstructure so as to at least partly empty the at least one microstructure.

According to still another exemplary embodiment, a microfluidic chip is provided, comprising a substrate and at least one microstructure formed on and/or in the substrate, wherein the at least one microstructure is cleaned at least partly from remnant material removed from the at least one microstructure so as to at least partly empty the at least one microstructure.

According to still another exemplary embodiment, a fluid separation system (for instance a gel electrophoresis device or a liquid chromatography device) for separating compounds of a fluid is provided, the fluid separation system comprising a fluid delivering unit for delivering (or supplying) the fluid (for instance from one or more fluid containers holding analyt, buffer or other solutions), and a separation unit (for instance comprising gel in case of a gel electrophoresis device or comprising beads for a column of a liquid chromatography device) adapted for separating compounds of the fluid, wherein the separation unit comprises a microfluidic chip having the above mentioned features, wherein the fluid is insertable in the at least one microstructure of the microfluidic chip.

According to an exemplary embodiment, a microchannel which has been blocked by gel material or any other impurities may be cleaned and cleared of the blocking material so that the microfluidic chip treated in such a manner may be used again without the danger that a measurement is disturbed by analyt which is blocked during transport through the microchannels. Thus, resources may be saved and the amount of generated waste may be reduced. Furthermore, a cost efficient bioanalysis may be made possible which may have significant advantages in the context of high throughput analysis in life science.

According to an exemplary embodiment, the cleaning process may include disassembling the chip (for instance made of glass material) from a caddy (which may be an electrically insulating substrate to be coupled to the chip). For instance, the disassembly of the glass chip may be promoted by heating the microfluidic chip to a sufficiently high temperature of, for instance, 100° C. This may allow to remove the caddy from the glass chip. Additionally or alternatively, it is possible to remove the caddy from the glass chip using a suitable solvent.

Furthermore, so-called sippers may be removed from the chip before cleaning. Sippers may be glass/quartz capillaries which may be connected to the chip to provide a fluid communication between microchannels of the chip and containers including analyt, buffer, or other fluids so as to enable to insert these fluids into the microstructures. Sippers may be made of a glass/quartz material or the like and may be connected to the glass chip using glue. For removing the sippers from the glass chip, the sippers may be cut out (for instance with a blade) of the glass chip. Also the disassembly of the sippers from the glass chip may be promoted by heating the microfluidic chip to a sufficiently high temperature of, for instance, 100° C., in order to soften or grow soft the glue. Additionally or alternatively, it is possible to remove the sippers from the glass chip using a suitable solvent which may make the glue soft again.

Further, the chip, after having removed the caddy and/or the sipper(s), may be heated to a sufficiently high temperature to “bake” material blocking the microchannels. For this purpose, it may be suitable to heat the naked glass chip for 12 hours at a temperature of 420° C. More generally, the temperature for baking the material to be removed may be (significantly) higher than the temperature for removing the caddy and/or the glass chip.

By this baking process, the blocking material may be chemically altered or modified so that the thus modified material may be removed from the microchannels easily. For instance, an (ultrasonic) cleaning may be carried out, or the material may be also be removed using applying pressure to the channels comprising the baked material.

Optionally, the cleaned chip can be made subject of reconditioning (which may be advantageous for RNA assays) so that surface properties of the microstructures may be adjusted or the inner wall surface may be regenerated to have desired properties.

After cleaning and optional reconditioning, the components may be reassembled, that is the cleaned chip may be connected to the caddy and/or the sippers may be mounted to be in fluid connection with microstructures of the chip.

Additionally or alternatively to the baking and the ultrasonic cleaning, the microstructures may be made subject of an ultraviolet radiation irradiation (UV-A), and/or a radioactive irradiation. For the latter purpose, alpha, beta or gamma rays may be impinged onto the chip to be cleaned.

According to an exemplary embodiment, microfluidic chips may be treated to be reusable. Such microfluidic chips may be, for instance, microfluidic chips to be used with a Bioanalyser system or an Automated Lab on Chip Platform (ALP) system of Agilent Technologies.

By a pyrolysis treatment of the chips, gel or other impurities blocking the channels may be oxidized, so that this chemically modified material can be easily removed from the microstructures.

According to another exemplary embodiment, the cleaning, recovery and/or regeneration method may be performed during carrying out an experiment, to avoid or eliminate problems occurring during a running experiment. By taking this measure, it can be ensured that an experiment during which a problem due to a blocking of the microstructures occurs can be continued, so that a precious analytical sample is not wasted or destroyed.

After having carried a measurement, the analyzed sample may be removed from the microstructures by rinsing or the like. For instance, a pressure may be applied for this purpose. By taking this measure, it may be possible to reuse a glass chip for instance thousand or two thousand times. However, after this long time of use, it may happen that the channels are irreversibly blocked by dirt, gel or other impurities. Thus, the glass chip may degrade by long-term use and may not be usable again. However, according to an exemplary embodiment, the microchannels blocked by sample or gel may be cleaned so as to be reused.

The glass chips removed from caddy and/sippers may comprises two bonded glass substrates. The bonded glass chips may be baked for removing gel, buffer remnant (for instance Tris buffer), etc. For instance, a heating to 430° C. for 12 hours in normal air may be appropriate. By enriching the atmosphere with oxygen, for example by increasing the oxygen content in the atmosphere, the cleaning process may be accelerated, since the oxidation which may be carried out during baking may be promoted by an excess of oxygen material. For example, a heating in a 100% oxygen atmosphere at a temperature of larger than 250° C. may be suitable. However, it may also be appropriate to keep the baking temperature below or equal 550° C., in order to avoid a deterioration of the material of the chip, for instance glass, for example to avoid diffusion processes in the glass or the like. Therefore, a temperature interval between 250° C. and 550° C. may be suitable, preferably between 350° C. and 450° C.

Oxidized (salt) rests (for instance chlorides or the like) may be removed by ultrasonic treatment, if desired accompanied by the addition of distilled water. If appropriate, an acid or a lye may be added for dissolving insolvable or difficultly solvable salts. After having treated the glass chip for removing disturbing material from the microchannels, the microchip array may be reassembled. In order to adapt surface properties of the microchannels to fit to the requirements of a particular experiment, it may be suitable to remove material remaining on the surface of the microchannels. For this purpose, a treatment with a sodium lye may be appropriate.

As an alternative to the baking of the chip for oxidizing the impurities, it may also be suitable to chemically oxidize, for instance using a chrome sulphur acid (which may be pumped through the channels) or by an organic oxidizing agent.

As a further alternative, pressure may be applied to the microchannels in order to pump the channels empty using a mechanical force acting on the impurities. If desired or necessary, this can be combined with the application of ultrasonic sound.

As a further alternative or additional measure, the channels may be irradiated with X-rays or ultraviolet radiation for breaking bonds between wall material of the substrate delimiting the microstructures on the one hand and the impurities on the other hand. This may, if desired, be accompanied by supplying oxygen or by treating the microfluidic chip in an oxygen enriched atmosphere.

In the following, it will be described how a sipper may be reassembled to the (cleaned) microchip. First, the sipper being a (for instance glass/quartz) capillary is inserted in a through hole or a bore formed in one of the glass substrates. Then, glue is provided between the sipper and the glass chip. The glue may be hardened by ultraviolet irradiation (for instance with one minute waiting time). Alternatively, a glue may be used which adheres without external treatment, for instance a two component glue.

Additionally, the chip may be adapted for a better cleanability. For instance, plastics material may be used for the chip instead of glass, wherein plastics may have the advantage that two bonded plastics substrates may be more easily be separable from one another than two bonded glass chips. As an alternative to a bonding connection, the connection between the two substrates may also be realized using a suitable glue or a mechanical connection element. As a further measure for adapting the chip for a better cleanability, a detachable (for instance clamp) connection between two substrates may be implemented. A microfluidic chip may be manufactured on the basis of glass chips, plastics chips, semiconductor chips, or the like.

Furthermore, it may appropriate to recondition the cleaned chip. In other words, specific binding properties of the material of the chip may be regenerated. For instance, it may be desirable for using the microchip for a gel electrophoresis experiment that fluorescence dye adheres to the inner wall surface of the microstructures. This may be advantageous, for instance, for RNA chips. For reconditioning, it may be appropriate to temper the cleaned chip to a temperature of 50° C. with a fixed humidity at a specific pressure.

Additionally or alternatively, the surface may be coated with a layer having desired material properties to make the microchip fit for a particular microfluidic application. For instance, coating an inner wall surface of the microchannels using a polyvinyl alcohol treatment may be appropriate. By coating the inner capillary surface, the surface properties may be improved.

Exemplary fields of application are chemical/biochemical analysis systems or reactors.

In the following, further exemplary embodiments will be described.

Next, exemplary embodiments of the method of cleaning a microfluidic chip will be described. However, these embodiments also apply for the microfluidic chip and for the fluid separation system.

The removing may comprise removing solid material from the at least one microstructure. Solid material is particularly prone to blocking the microstructures so that the removal of solid material may significantly improve the quality of an already used chip which is treated so as to be reusable.

The removing may further comprise heating the microfluidic chip. By heating, impurities may be hardened, solidified, oxidized or otherwise modified chemically and may then be simply removable from the microstructure, since the chemical modification may weaken bonds between the impurities and wall material of the microstructures.

For instance, the microfluidic chip may be heated to a temperature in the range between 250° C. and 550° C., particularly between 350° C. and 450° C. In these temperature ranges it may be ensured that the solid material is significantly modified concerning the chemical properties so as to be easily removable from the microstructures. Simultaneously, such temperatures are low enough to prevent material of the substrate of the microfluidic product to be cleaned from being modified in an undesired manner.

The removing may comprise heating the microfluidic chip for a time interval in a range between 1 hour and 12 hours, particularly between 4 hours and 8 hours. Thus, the cleaning process is sufficiently fast to be carried out, for instance, over night or in an industrial environment so that cleaning may be more economical and ecological than manufacturing a new microfluidic chip.

Furthermore, the removing may comprise heating the microfluidic chip in an air atmosphere (which may have an oxygen contribution of essentially 20%), in an oxygen-enriched atmosphere (which may have an oxygen contribution which is artificially increased with respect to essentially 20%) or in an atmosphere consisting essentially of oxygen (which may have an oxygen contribution of almost 100%). The more oxygen being present in the environment, the more are the impurities in the microchannels prone to be oxidized and therefore significantly altered chemically, so that the thus modified material can be easily removed from the microstructures.

The removing may comprise irradiating the microfluidic chip with ultrasonic waves. By taking this measure, the bonding between the disturbing material and the walls of the microstructures may be weakened (“ultrasonic cleaning”).

The removing may further comprise irradiating the microfluidic chip with ultrasonic waves transmitted using an aqueous solution, an acid, and/or a lye. By pumping a liquid through the microchannels and by propagating ultrasonic waves through this fluid, an efficient physical interaction between the fluid and the impurities adhering on the walls may be achieved. When using an acid or a lye, an additional chemical interaction may be promoted between the impurities and the solvent through which the ultrasonic waves are propagating.

The removing may comprise irradiating the microfluidic chip with electromagnetic radiation, additionally or alternatively to the irradiation with ultrasonic waves. Also the interaction between electromagnetic radiation (particularly infrared radiation, visible light, ultraviolet radiation or X-rays) may interact with the impurities so as to change their chemical properties to make the microchannels cleanable in an accurate manner.

The removing may further comprise irradiating the microfluidic chip with radioactive radiation, for instance with alpha, beta and/or gamma radiation. This may support removal of the impurities from the microchannels.

The removing may comprise applying a pressure to the at least one microstructure. By connecting a vacuum pump or a high pressure pump to the microchannels, thus applying a suitable pressure, the bonding between the disturbing material and the microstructures may be destroyed so as to remove the material from the microstructures.

The removing may comprise chemically oxidizing the material to be removed from the at least one microstructure. For this purpose, an oxidizing agent may be inserted in the microchannels.

The method may further comprise, before the removing, disassembling a carrier element from the substrate. Such a carrier element or caddy may be removed from the substrate since it may inappropriate to treat such a carrier element at high temperatures which may be appropriate for baking material to be removed from the microchannels.

The disassembling may comprise tempering the microfluidic chip before the disassembling so as to promote disassembly. This may break a bonding between the caddy and the glass chip, for instance weaken a glued connection.

This tempering may comprise heating the microfluidic chip to a temperature in the range between 70° C. and 150° C., particularly essentially 100° C., which is a temperature range in which the carrier element is usually not effected or negatively influenced.

The method may further comprise, before the removing, demounting a sipper device coupled to at least one of the at least one microfluidic structure and adapted to convey fluid and/or gel to the at least one microfluidic structure. Such a sipper may be removed since the bonding between the sipper and the glass chip (for instance glue) may be destroyed at high temperatures which may be applied for removing blocking material from the microstructures.

The demounting may comprise cutting the sipper device out of the substrate. This can be promoted by a blade and/or by a suitable chemical agent.

The method may further comprise, after the removing, reassembling the carrier element to the substrate. After having reassembled the carrier element to the substrate and, optionally, having remounted the sipper device to the microchip, the latter may be ready for a new use.

The method may further comprise, after the removing, reconditioning the microfluidic chip for a specified microfluidic chip application. This reconditioning may include adjusting the at least one microfluidic structure for the microfluidic chip application. For instance, the adjusting may comprise tempering the microfluidic chip and/or coating a surface of the at least one microfluidic structure with a suitable material.

In the following, exemplary embodiments of the microfluidic chip will be described. However, these embodiments also apply for the method of cleaning a microfluidic chip and for the apparatus for cleaning a microfluidic chip.

The at least one microstructure may comprise at least one channel for channeling fluid and/or gel. Such a channel may have dimensions in the order of magnitude of micrometers, nanometers, or millimeters. The channels may be formed horizontally on and/or in a surface of the substrate, that is essentially in or slightly below the surface plane.

Additionally or alternatively, the at least one microstructure may comprise at least one through hole for conveying fluid and/or gel into the at least one channel. Such a through hole may be formed in one of the substrates, for instance vertically, to allow an external access to the channels. For instance, a material may be pumped through a through hole into a directly connected channel which is in fluid communication with the through hole.

The substrate may comprise at least one of the group consisting of a glass, a semiconductor material, a plastics material, a ceramics material and a metallic material. When implementing a semiconductor material, this can be silicon or germanium (that is to say a group IV semiconductor), or it can also be a group III-V semiconductor, like gallium arsenide.

The microfluidic chip may comprise a second substrate coupled to the first substrate, wherein the second substrate may comprise at least one microchannel, wherein at least one of the at least one microchannel of the second substrate may be aligned to be in fluid communication with at least one of the at least one microchannel of the first substrate. By this, an arrangement of two bonded or otherwise connected substrates forming the microfluidic chip may be obtained.

The second substrate may be coupled to the first substrate by bonding, by gluing, by clamping, or the like.

For promoting the cleaning feature according to an exemplary embodiment, it may be appropriate that the connection of the first substrate to the second substrate is reversible, so that the second substrate can be easily detached from the first substrate.

The microfluidic chip may be adapted to analyze at least one of the group consisting of a physical, a chemical and a biological parameter of at least one component of a fluid. The term “physical parameter” may particularly denote a temperature, a pressure, a size. The term “chemical parameter” may comprise a concentration, a pH value or the like. The term “biological parameter” may include a biological activity of a sample or the presence and/or concentration of a component like a protein or a gene in the sample.

Furthermore, the microfluidic chip may be adapted as at least one of a sensor device, a device for chemical, biological and/or pharmaceutical analysis, a gel electrophoresis device, a capillary electrophoresis device, a liquid chromatography device, a gas chromatography device, an electronic measurement device, and a mass spectroscopy device. Exemplary fields of application of the system according to embodiments are electrophoresis applications, in which electric fields are applied to the different channels. Using the electric fields, electric forces may be affected on the particles to be analyzed so that a separation of these particles may become possible. Further exemplary fields are gel electrophoresis devices, in which an analyt is pumped through a gel. Capillary electrophoresis comprises the transport of components under the influence of an electric field through capillaries having a small diameter.

The microfluidic device may comprise a sipper device coupled to at least one of the at least one microfluidic structures and adapted to convey fluid and/or gel to the at least one microfluidic structure.

Furthermore, the microfluidic chip may comprise a carrier element (which may also be denoted as a caddy) to be coupled to the substrate. The carrier element may be detachably or fixedly connected to the substrate.

When the carrier element is coupled to the substrate in a detachable manner, this may simplify the cleaning procedure.

### BRIEF DESCRIPTION OF DRAWINGS

Other objects and many of the attendant advantages of embodiments will be readily appreciated and become better understood by reference to the following more detailed description of embodiments in connection with the accompanied drawings. Features that are substantially or functionally equal or similar will be referred to by the same reference signs.

FIG. 1 illustrates a fluid separation system comprising a microfluidic chip according to an exemplary embodiment.

FIG. 2 illustrates the microfluidic chip of FIG. 1 during a method of cleaning the microfluidic chip according to an exemplary embodiment.

FIG. 3 shows the microfluidic chip of FIG. 1 during the method of cleaning the microfluidic chip according to an exemplary embodiment.

FIG. 4 illustrates the microfluidic chip of FIG. 1 during the method of cleaning the microfluidic chip according to an exemplary embodiment.

FIG. 5 illustrates a microfluidic chip to be cleaned according to an exemplary embodiment.

FIG. 6 illustrates the microfluidic chip of FIG. 5 during a method of cleaning the microfluidic chip according to an exemplary embodiment.

FIG. 7 illustrates the microfluidic chip of FIG. 5 during the method of cleaning the microfluidic chip according to an exemplary embodiment.

FIG. 8 illustrates the microfluidic chip of FIG. 5 during the method of cleaning the microfluidic chip according to an exemplary embodiment.

FIG. 9 illustrates a microfluidic chip according to an exemplary embodiment.

The illustration in the drawing is schematically.

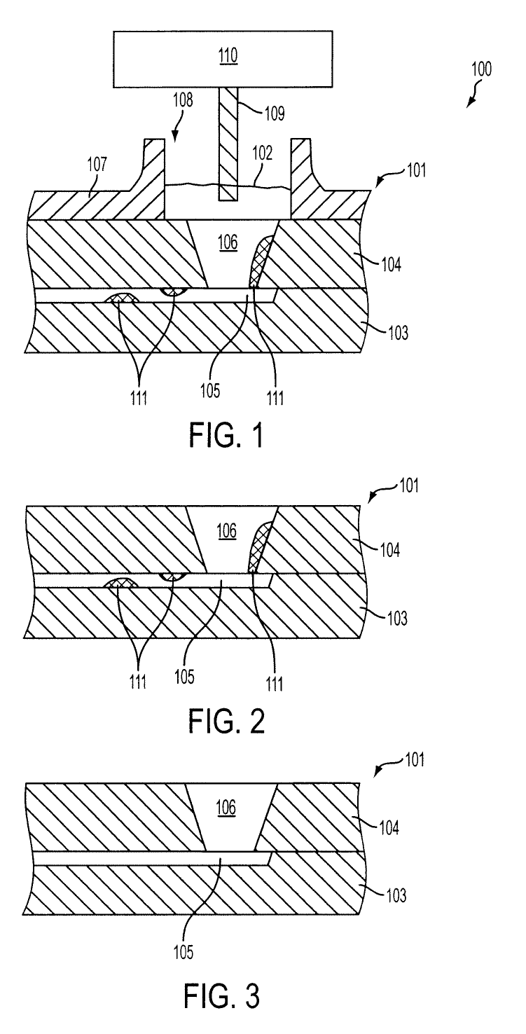

In the following, referring to FIG. 1, a fluid separation system 100 for separating components of a fluid according to an exemplary embodiment will be described.

The fluid separation system 100 comprises a fluid delivering system for delivering fluid 101 to be investigated from containers holding sample material, buffers, and other solutions. Furthermore, an electrophoresis separation system is provided for separating components of the fluid 101. The separation system comprises a microfluidic chip 102, wherein the fluid 101 is insertable in microstructures 105, 106 of the microfluidic chip 102.

The microfluidic chip 102 comprises a first glass substrate 103, a second glass substrate 104 bonded with the first glass substrate 103 and a plurality of microstructures 105, 106 formed in the first and in the second glass substrates 103, 104.

The microstructures 105, 106 of the microfluidic chip 102 include microchannels 105 formed in the first glass substrate 103 and running in a horizontal direction with respect to FIG. 1. The microchannels 105 are adapted for channeling the fluid 101 and a gel which may also be present in the microchannels 105 in the context of a gel electrophoresis application.

The microstructures 105, 106 of the microfluidic chip 102 further comprise through holes 106 formed in a vertical direction with respect to FIG. 1 for conveying the fluid 101 and the gel into the microchannels 105.

As can be seen in FIG. 1, the second glass substrate 104 is bonded to the first glass substrate 103 in such a manner that the microchannels 105 are aligned to be in fluid communication with the through holes 106, or in other words, to form a fluidic connection.

The gel electrophoresis device 100 is adapted to analyze biological parameters of the sample or analyt 101. The microfluidic chip 102 comprises a carrier element or a caddy 107 which is adheringly connected to the second glass substrate 104 using glue. The carrier element 107 defines a well 108 serving as an external access to the fluid 101. A pin 109 serving as an electrical contact dips into the fluid 101 so as to apply an electric field to the fluid 101, as desired in the context of a gel electrophoresis experiment. The application of an electric current or an electric voltage to the contact pin 109 can be realized or controlled using a control device 110 of the fluid separation system 100.

During operation of the device 100 in an electrophoresis experiment, a fluid as well as gel material is inserted in the microstructures 105, 106. Then, the voltage is applied to the fluid 101 using the contact pins 109 and the control device 110 so that the components of the fluid 101 may be separated under the influence of an electric field.

However, when the microfluidic device 102 has been used for a long time or several times it may happen that solid material 111 adheres at walls of the through holes 106 and/or of the capillaries 105. This may prevent fluid 101 and/or gel from being transported properly through the channels 105. Therefore, the functionality of the fluid separation system 100 may be deteriorated.

To remove such residues or remnants, a method for cleaning the microfluidic chip 102 may be carried out, which will be described in the following.

First, the carrier element 107 may be removed from the second glass substrate 104. The resulting structure is shown in FIG. 2.

For this purpose, the microfluidic chip 101 may be tempered before disassembling the caddy 107 by heating the microfluidic chip 101 to a temperature of approximately 100° C.

By taking this measure, a glue connection between the second glass substrate 104 and the caddy 107 may be weakened and the caddy 107 may be removed from the glass chips 103, 104.

Then, the solid particles 111 are removed from the microstructures 105, 106 so as to empty the microstructures 105, 106. The removing comprises heating the microfluidic chip 101 in an oven to a temperature of 430° C. for 12 hours in an oxygen enriched atmosphere. This may have the consequence that the solid particles 111 are chemically modified so that they may be easily removed afterwards.

For removing the baked particles 111, the microfluidic chip 102 may be irradiated by ultrasonic waves. For this purpose, an aqueous solution may pumped through the channels 106 and/or the through holes 105. For removing the hardened and/or dissolved particles 111, a mechanical pressure may be applied to the microstructures 105, 106.

As a consequence, as shown in FIG. 3, the particles 111 are removed from the microchannels 105 and from the through holes 106.

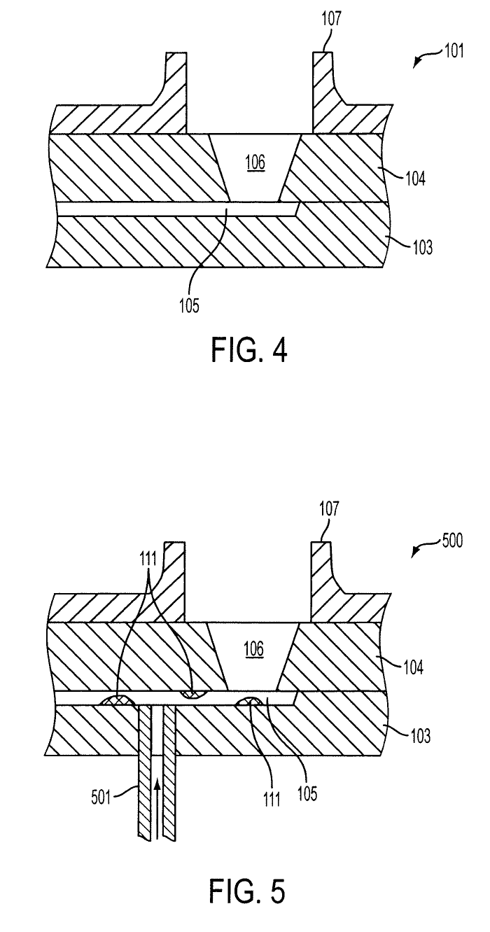

As shown in FIG. 4, after having removed the particles 111 from the microchannels 105, 106, the caddy 107 can be remounted on the second glass chip 104, for example by gluing.

Optionally, a polyvinyl alcohol or a chemically similar substance may be pumped through the microstructures 105, 106 to selectively modify the inner wall surfaces of the microchannels 105, 106 so as to make the treated microchip 101 fit for a new use.

In the following, referring to FIG. 5, a microchip array 500 according to an exemplary embodiment will be described.

The microchip array 500 differs from the microfluidic chip 101 in that a sipper 501 is provided which is connected to the first glass substrate 103 so as to contact the channel 105. Thus, the sipper device 501 is coupled to the channels 105 so as to allow to introduce gel and/or fluid in the microchannels 105.

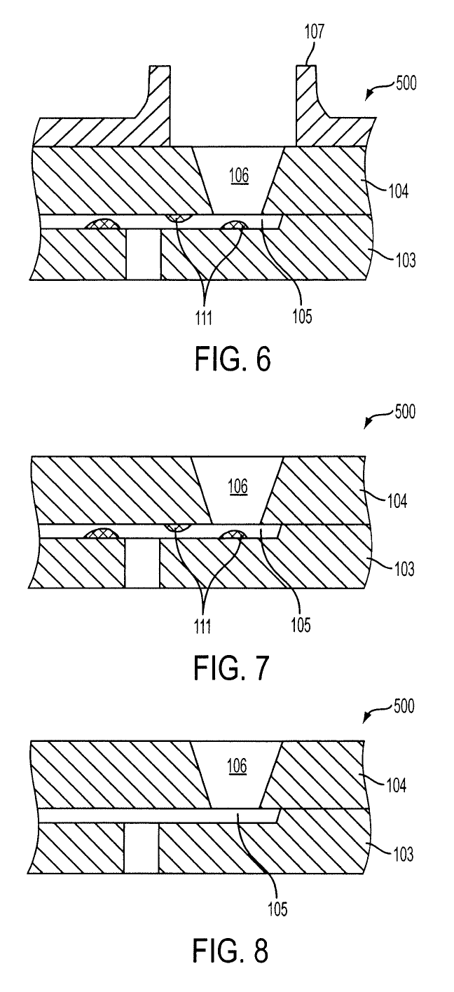

In the following, referring to FIG. 6 to FIG. 8, it will be described how the microfluidic chip 105 can be cleaned in order to make the microfluidic chip 500 reusable by removing impurities 111 from the microchannels 105.

First, as shown in FIG. 6, the sipper device 501 is removed from the microfluidic chip 500. For this purpose, a blade may cut off the sipper 501 being connected by a glue to the first glass substrate 103. This can be promoted by a chemical agent capable of dissolving the glue.

Next, as shown in FIG. 7, the caddy 107 may be disassembled from the glass chips 103, 104 by tempering the microchip array 500 to 100° C., optionally supported by a chemical treatment, so as to dissolve or weaken the glue connection between the second glass chip 104 and the caddy 107.

After having removed the caddy 107, the so obtained microchip array 500 may be treated to bake the particles 111 by heating the microchip array 500 to a temperature of 430° C. for 12 hours in a 100% oxygen atmosphere. Simultaneous to this baking procedure, the compounds 111 may be irradiated with ultraviolet radiation. After such a treatment, the particles 111 can be easily removed. Namely, by applying a pressure to the microstructures 105, 106, the hardened and destabilized impurities 111 are removed from the channels 111 by pumping.

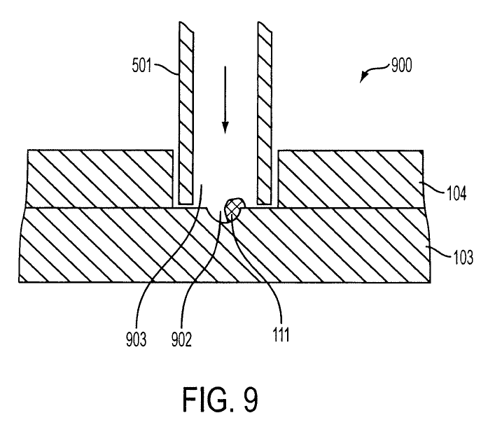

The result is shown in FIG. 8, namely the bonded glass chips 103, 104 without the impurities 111.

Next but not shown in the figures, the caddy 107 may be remounted onto the top of the second glass substrate 104, similarly as shown in FIG. 4. Then, the treated microfluidic chip 500 is recycled and may be reused for further gel electrophoresis experiments.

FIG. 9 shows a microfluidic chip 900 according to an exemplary embodiment.

The microfluidic chip 900 again comprises a first glass substrate 103 and a second glass substrate 104 bonded to the first glass substrate 103, wherein a channel 902 is formed in the first glass substrate 103, and a through hole 903 is formed in the second glass substrate 104. A sipper 501 is connected to the second glass substrate 104.

Again, after removing the sipper 501,the compound 111 can be removed by baking and reconditioning the chip 900.

It should be noted that the term “comprising” does not exclude other elements or processes and the “a” or “an” does not exclude a plurality. Also elements described in association with different embodiments may be combined. It should also be noted that reference signs in the claims shall not be construed as limiting the scope of the claims.

1. A method of cleaning a microfluidic chip comprising at least one microstructure containing a material, wherein the method comprises
removing the material from the at least one microstructure so as to at least partly empty the at least one microstructure,
wherein the removing comprises at least one of:
heating the microfluidic chip;
irradiating the microfluidic chip with at least one of ultrasonic waves, electromagnetic radiation, and radioactive radiation;
chemically oxidizing the material to be removed from the at least one microstructure.

2. The method of claim 1, wherein the heating of the microfluidic chip comprises at least one of:
heating to a temperature in a range between essentially 250° C. and essentially 550° C., or in a range between essentially 350° C. and essentially 450° C.;
heating the microfluidic chip for a time interval in a range between essentially 1 hour and essentially 12 hours, or in a range between essentially 4 hours and essentially 8 hours;
heating the microfluidic chip in one of the group consisting of an air comprising atmosphere, an oxygen-enriched atmosphere, and an atmosphere consisting essentially of oxygen.

3. The method of claim 1, wherein the irradiating of the microfluidic chip comprises at least one of:
irradiating the microfluidic chip with ultrasonic waves transmitted using at least one of the group consisting of an aqueous solution, an acid, and a lye;
irradiating the microfluidic chip with electromagnetic radiation of at least one of the group consisting of infrared radiation, visible light, ultraviolet radiation, and X-rays.

4. The method of claim 1, comprising at least one of:
tempering the microfluidic chip before the disassembling, wherein preferably the tempering comprises heating the microfluidic chip to a temperature in the range between essentially 70° C. and essentially 150° C.;
before the removing, demounting a sipper device coupled to at least one of the at least one microfluidic structure and adapted to convey fluid and/or gel to the at least one microfluidic structure, wherein preferably the demounting comprises cutting the sipper device out of the microfluidic chip, and after the removing, preferably remounting the sipper device to the at least one of the at least one microfluidic structure.

5. The method of claim 1, comprising
after the removing, reconditioning the microfluidic chip for a specified microfluidic chip application, wherein the reconditioning preferably comprises adjusting the at least one microfluidic structure for the microfluidic chip application, and the adjusting preferably comprises at least one of tempering the microfluidic chip and coating a surface of the at least one microfluidic structure.

6. The method of claim 1, comprising at least one of:
the removing comprises removing solid material from the at least one microstructure;
the removing comprises applying a pressure to the at least one microstructure;
the removing comprises applying an overpressure or a low pressure to the at least one microstructure;
before the removing, disassembling a carrier element from the microfluidic chip;
after the removing, reassembling a carrier element to the microfluidic chip.

7. An apparatus for cleaning a microfluidic chip comprising at least one microstructure containing a material, wherein the apparatus comprises
a removing unit adapted for removing the material from the at least one microstructure so as to at least partly empty the at least one microstructure,
wherein the removing comprises at least one of the following:
heating the microfluidic chip;
irradiating the microfluidic chip with at least one of ultrasonic waves, electromagnetic radiation, and radioactive radiation;
chemically oxidizing the material to be removed from the at least one microstructure.

8. A microfluidic chip, comprising
a substrate;
at least one microstructure formed on and/or in the substrate;
wherein the at least one microstructure is cleaned at least partly from remnant material removed from the at least one microstructure so as to at least partly empty the at least one microstructure,
wherein the removing of the remnant material is provided by at least one of the following:
heating the microfluidic chip;
irradiating the microfluidic chip with at least one of ultrasonic waves, electromagnetic radiation, and radioactive radiation;
chemically oxidizing the material to be removed from the at least one microstructure.

9. The microfluidic chip of claim 8, comprising at least one of:
the at least one microstructure comprises at least one channel for channeling fluid and/or gel;
the at least one microstructure comprises at least one channel for channeling fluid and/or gel and comprises at least one through hole in fluid communication with the at least one channel;
the substrate comprises at least one of the group consisting of glass, a semiconductor material, a plastics material, a ceramics material and a metallic material;
the microfluidic chip comprises a further substrate coupled to the substrate, wherein the further substrate comprises at least one microstructure, wherein at least one of the at least one microstructure of the further substrate is aligned to be in fluid communication with at least one of the at least one microstructure of the substrate;
the microfluidic chip is adapted to analyze at least one of the group consisting of a physical, a chemical and a biological parameter of at least one compound of a fluid;
the microfluidic chip is adapted as at least one of a sensor device, a device for chemical, biological and/or pharmaceutical analysis, a gel electrophoresis device, a capillary electrophoresis device, a liquid chromatography device, a gas chromatography device, an electronic measurement device, and a mass spectroscopy device;
the microfluidic chip comprises a sipper device coupled to at least one of the at least one microfluidic structure and adapted to convey fluid and/or gel to the at least one microfluidic structure;
the microfluidic chip comprises a carrier element to be coupled to the substrate;
the microfluidic chip comprises a carrier element to be coupled to the substrate, wherein the carrier element is to be coupled to the substrate in a detachable manner.

10. The microfluidic chip of claim 9, comprising at least one of:
the further substrate is coupled to the substrate using at least one of bonding, gluing, and clamping.

11. A fluid separation system for separating compounds of a fluid, the fluid separation system comprising
a fluid delivering unit for delivering the fluid;
a separation unit adapted for separating compounds of the fluid;
wherein the separation unit comprises a microfluidic chip of claim 8, wherein the fluid is insertable in the at least one microstructure.
